(19) United States
(12) Patent Application Publication
(10) Pub. No.: US 2011/0286801 A1
(43) Pub. Date: Nov. 24, 2011

(54) J-LAY SYSTEM WITH DUAL LOADING CAPABILITY

(75) Inventors: Gerardus Cornelius Van Grieken, Noordwijkerhout (NL); Walter Petrus Johannes Wassenaar, Den Haag (NL)

(73) Assignee: HEEREMA MARINE CONTRACTORS NEDERLAND B.V., Leiden (NL)

(21) Appl. No.: 13/140,460

(22) PCT Filed: Dec. 16, 2009
(86) PCT No.: PCT/NL2009/000260

§ 371 Date: Jul. 6, 2011

Related U.S. Application Data
(60) Provisional application No. 61/139,049, filed on Dec. 19, 2008.

(30) Foreign Application Priority Data
Dec. 19, 2008 (NL) 2002348

(51) Int. Cl. F16L 1/12

(52) U.S. Cl. 405/166

(57) ABSTRACT

A pipeline laying vessel includes a J-lay system which defines a firing line. The J-lay system includes at least one lowering device for lowering a pipe section or pipeline in the firing line from an upper position to a lower position. The vessel further includes a first pipe-moving device and a second pipe-moving device, where the first pipe-moving device is configured for moving a pipe section from a first remote position remote from the firing line to a firing line position in the firing line, and the second pipe-moving device is configured for moving a pipe section from a second remote position remote from the firing line to the firing line position in the firing line. A method for laying a pipeline uses the above mentioned pipeline laying vessel.

### CROSS-REFERENCE TO RELATED APPLICATIONS

This application is the National Stage of International Application No. PCT/NL2009/000260, filed Dec. 16, 2009, which claims the benefit of Netherlands Application No. 2002348, filed Dec. 19, 2008, and the benefit of U.S. Provisional Application No. 61/139,049, filed, Dec. 19, 2008, the contents of all which are incorporated by reference herein.

### FIELD OF THE INVENTION

The present invention relates to a pipeline laying vessel comprising a J-lay system. The present invention also relates to a method of laying a pipeline on a seabed with a J-lay system.

### DISCUSSION OF THE PRIOR ART

J-lay systems are widely known in the field of marine pipelaying. Oil & gas are found in ever-increasing water depths, and pipelines are required to transport these oil & gas reserves from the boreholes at the bottom of the waters in which they are found to locations where the product can be treated and/or prepared for further transport.

Many pipelines have been laid on seabeds, and many more are expected to be laid. Different technologies exist for laying such pipelines. One known technology is S-lay and another known technology is J-lay. Other technologies also exist.

In J-lay, a pipeline is suspended from a vessel at an angle which corresponds to the natural angle of the pipeline under the influence of factors such as water depth, pipeline diameter, and thrust of the vessel. Pipe sections are joined to the free end of the pipeline while the vessel itself progressively moves forward. Each added pipe section extends the pipeline and allows the vessel to move forward. The pipeline slowly moves downward to the seabed where it comes to a rest.

Advantages of J-lay include amongst others that the pipe does not experience plastic deformation during installation, large structures can be inserted in the pipeline with relative ease and very heavy pipelines in very deep water can be installed.

However, a problem known with J-lay is that it is a slow process when compared to other pipelay methods. Many factors influence the speed of J-lay. However, the day rates of J-lay vessels are very high. This, there is a constant need in the field of the art to increase the speed at which pipeline can be laid in J-lay mode.

Moreover, J-lay is a complex process, requiring a system comprising many parts and subsystems which should cooperate in creating the pipeline. There is a constant danger that one of the parts or subsystems breaks down, which causes the entire J-lay operation to be discontinued. In view of the high day rates of J-laying vessels this causes substantial financial losses. Because in a J-lay system the parts and subsystems are interdependent, there is a chain of parts and subsystems, and one failure can break down the entire chain. Therefore, there is a constant need in the field of the art to simplify the individual parts and subsystems, and to leave out parts and/or subsystems in order to decrease the amount of links in the chain.

A known J-lay system is described in U.S. Pat. No. 6,524,030. This J-lay system comprises a vessel, a tower 14 mounted on the vessel and a welding station and other processing stations inside the J-lay tower. The pipeline is suspended from tensioners or friction clamps and the J-lay tower is pivotably mounted in order to be aligned with the natural angle of the pipeline.

A disadvantage of this system is that it is complex. The pipe section must be picked up from the deck by an upender, rotated, handed over to and moved upwards by an elevator, inserted into and handed over to the J-lay tower, aligned with the suspended pipeline, welded to the pipeline, tested, coated, and lowered. All these steps take costly time. Moreover, the individual parts and subsystems shown in U.S. Pat. No. 6,524,030 can break down, and this leads to the non-working of the entire system.

Furthermore, two handover procedures are required, i.e. one from the upender to the elevator and one from the elevator to the alignment device inside the J-lay tower. Both these handover operations are dangerous, because any loss of control may result in the pipe section falling downwards, onto the deck of the vessel.

Another known system is disclosed in WO2008/099355. A loader arm 5 is mounted on the deck of a pipeline laying vessel. The J-lay system has no separate J-lay tower, as is the case in the system of U.S. Pat. No. 6,524,030. In U.S. Pat. No. 6,524,030, the J-lay tower comprises an alignment system for aligning a new pipe section with the pipeline and a lowering system for lowering the pipe section and the pipeline after the pipe section has been connected to the pipeline. In WO2008/099355, a pipe manipulation system 25, 26 is provided on the loader for aligning the pipe section with the pipeline. Further, a movable clamp 22 is either provided below the vessel or on the loader, see p. 3, line 32 and further. Thus, the system of WO2008/099355 is simplified with respect to the system of U.S. Pat. No. 6,524,030 in that no J-lay tower is necessary.

However, the first embodiment with the movable clamp 22 below the vessel has severe disadvantages because the lowering clamp is not accessible during operations. Any problem occurring with the lowering clamp should be dealt with under water via an ROV or with divers.

The second embodiment with the lowering device 22 mounted to the loader also has a severe disadvantage in that the loader must remain aligned with the firing line and the pipeline during the entire cycle of aligning the pipe section with the pipeline, joining the pipe section with the pipeline and lowering the combined pipe section and pipeline. This leads to an extremely slow system. This embodiment is even slower than the conventional system disclosed in U.S. Pat. No. 6,524,030, because in U.S. Pat. No. 6,524,030 the loader can at least return to the deck to pick up a new pipe section while the previous pipe section is being joined with the pipeline. This is not possible with the second embodiment of WO2008/099355.

Another known J-lay system is disclosed in U.S. Pat. No. 6,273,643. This system uses an erector 25 to load a pipe into a mast 15 by transferring the pipe to an alignment system 46. A disadvantage of this system is that it is relatively slow.

### SUMMARY OF THE INVENTION

It is an object of the invention to provide a working alternative to the prior art.

It is an object of the invention to provide a faster J-lay system and method.

It is another object of the invention to provide a simpler and safer J-lay system and method.

It is another object of the invention to provided redundancy in the J-lay system and method, such that if one part or subsystem breaks down, it is possible to continue the J-lay process.

In order to achieve at least one of the above mentioned objects, the present invention provides a pipeline laying vessel comprising a J-lay system which defines a firing line, the J-lay system comprising:

a first pipe-moving device configured for moving a pipe section from a first remote position remote from the firing line to a firing line position in the firing line,

a second pipe-moving device configured for moving a pipe section from a second remote position remote from the firing line to the firing line position in the firing line,

at least one lowering device for lowering a pipe section or pipeline in the firing line from an upper position to a lower position.

In a suitable embodiment, the invention has the advantage that the pipe section is held with the pipe-moving device during at least a part of the joining operation with the pipeline. In this way, both of the handover steps from the system of U.S. Pat. No. 6,524,030 are obviated. This leads to a substantial simpler and safer J-lay process.

In an embodiment with two lowering devices, the lowering devices are associated with the pipe-moving devices, and a separate J-lay tower for supporting a lowering device is also obviated. This further increases the simplicity of the J-lay system relative to the system of U.S. Pat. No. 6,524,030.

With respect to the first embodiment of WO2008/099355 a system is obtained which has all essential elements above the water line, which facilitates repair and maintenance operations.

With respect to the second embodiment of WO2008/099355, a substantially faster J-lay process is possible with the present invention, because one pipe moving device may move a pipe section to the firing line while the other pipe-moving device is working with another pipe section in the firing line.

In view of other J-lay systems having a travelling block, additional time is saved, because the positioning of a next pipe section into the firing line does not require waiting for the lowering device to be hoisted back to its upper position. When one pipe-moving device is moved away from the firing line, the lowering device which is connected to that pipe-moving device is also moved out of the firing line and can be moved to the upward position outside the critical path. The firing line is immediately available for insertion of a next pipe section.

Furthermore, the invention obviates a handover procedure from a loader to an elevator and from an elevator to an alignment device as required in the system of U.S. Pat. No. 6,524,030.

Moreover, in case one of the pipe-moving devices malfunctions or needs maintenance or adjustments, the other pipe moving device can take over, and the J-lay process can continue. Possibly, the J-lay process continues at a lower speed, but at least the J-lay system does not break down completely. Thus, the system is at least partially redundant. This also applies to the second lowering device, which can take over in case the first lowering device malfunctions or needs maintenance.

In one embodiment the J-lay system comprises both a first and a second lowering device and a first and second pipe-moving device. In an embodiment, the first lowering device is connected to the first pipe-moving device and the second lowering device is connected to the second pipe-moving device.

This embodiment allows efficient and simple J-lay.

In a suitable embodiment, the first and second lowering devices are configured to alternately lower a pipe section or pipeline in the firing line. In an embodiment, the first pipe-moving device and the second pipe-moving device are configured to alternately move a pipe section to the firing line position.

An alternate movement is a simple way of achieving an increase in the speed and removing as much activity from the critical path as possible.

In a suitable embodiment, it is possible to use both the first and second lowering devices in combination on a single load, for instance when a large load is to be lowered.

In a suitable embodiment:

the first lowering device is movable into the firing line and out of the firing line to a first remote position remote from the firing line, and

the second lowering device is movable into the firing line and out of the firing line to a second remote position remote from the firing line.

This configuration is an effective way of ensuring that both lowering devices can alternately lower pipe sections in the firing line.

In a suitable embodiment:

the first lowering device is connected to the first pipe-moving device and

the second lowering device is connected to the second pipe-moving device.

In this embodiment, the first and second lowering devices can be conveniently moved away from the firing line with the respective pipe moving device. Further, a separate support construction for the lowering devices is no longer needed.

In a suitable embodiment:

the first pipe-moving device comprises a first elongate structure, wherein the first lowering device is movably constructed to make a stroke along the first elongate structure from an upper position to a lower position; and

the second pipe-moving device comprises a second elongate structure, wherein the second lowering device is movably constructed to make a stroke along the second elongate structure from an upper position to a lower position.

In this embodiment, the elongate structure also fulfils a function which is normally fulfilled by a separate J-lay tower. This embodiment can do without the separate J-lay tower and thus is a simple construction. Maintenance activities can be easily performed when the elongate structure is in the remote position from the firing line

In a suitable embodiment, the first and second pipe-moving devices are pivotable relative to the firing line via a hinge and are configured to pivot a pipe section from the respective remote positions to the firing line position.

This is a simple and reliable way of ensuring that the pipe-moving devices accurately bring the pipe sections to the firing line.

In a suitable embodiment, the first and second lowering devices are configured to be connected to pipe sections which are to be joined to the pipeline prior to the arrival of the pipe sections in the firing line position.

This allows an increase in speed, since the connecting of the lowering device to the pipe section can be performed outside the critical path.

In a suitable embodiment, the pipeline laying vessel comprises a first and a second alignment device. With this embodiment, a part of the alignment procedure can be carried out outside the critical path. While the first loader and/or alignment device is performing operations in the firing line, the second loader and/or alignment device can pre-align a next pipe section at a position close to the firing line but not in the firing line. For instance, the next pipe section may be inserted into the alignment device, gripped by the alignment device and be oriented parallel to the firing line such that the end face of the next pipe section is already parallel with the end face of the pipeline. All these activities can be performed outside the critical path

In one embodiment, the only part of the alignment which is performed inside the critical path is the insertion of the next pipe section in the firing line and the final adjustments for complete alignment of the pipe section with the pipeline.

Preferably, each alignment device is associated with a respective pipe-moving device and a respective lowering device. Preferably, the first and second alignment devices are configured to be engaged with pipe sections which are to be joined to the pipeline prior to the arrival of the pipe sections in the firing line position.

In a suitable embodiment,

the first pipe-moving device is configured to move the pipe section to the firing line position via a first almost-firing line position in which first almost-firing line position the pipe section engages a first alignment device, wherein the first pipe-moving device and the first alignment device are constructed to jointly move the pipe section from the almost-firing line position to the firing-line position, and

the second pipe-moving device is configured to move the pipe section to the firing line position via a second almost-firing line position, in which second almost-firing line position the pipe section engages a second alignment device, wherein the second pipe-moving device and the second alignment device are constructed to jointly move the pipe section from the almost-firing line position to the firing-line position.

Advantageously, a part of the aligning process can be performed outside the critical path. In one embodiment, the pipe section can be lowered into the alignment tool by the first or second moving device. To this end, holding devices (which may also be indicated as holders) which hold the pipe section comprise a pipe section lowering device with which the pipe section can be lowered into the alignment device.

In a suitable embodiment, the first and second pipe-moving device each comprise holding devices for holding the pipe section, wherein the holding devices are movably mounted to the respective pipe-moving devices, such that when the respective pipe-moving devices are positioned close to the firing line, the holding devices can move the pipe section from an almost-firing line position to the firing line position.

The pipe-moving device moves from the remote position to a position close to the firing line. Subsequently, the pipe section engages the alignment device. Next, the holding devices move relative to the pipe-moving device and move the pipe section into the firing line. The alignment device moves together with the pipe section into the firing line.

In one embodiment, the first and second almost-firing line positions are different positions. The first and second pipe-moving device each have their own trajectories and move the pipe section from the remote position to distinct positions near the firing line. The first and second almost-firing line position and the firing line position may form a triangle, when viewed from above. Thus, the paths from the respective almost firing-line positions converge at the firing line. This embodiment allows the pipe section to be inserted into the firing line from different positions. A further increase in speed is provided, because even more activities can be performed outside the critical path. At a given time, two pipe sections may be in the almost-firing line position simultaneously, waiting to be inserted into the firing line.

In a suitable embodiment, the first pipe-moving device and the first alignment device are constructed to jointly move the pipe section from the almost-firing line position to the firing-line position, and the second pipe-moving device and the second alignment device are constructed to jointly move the pipe section from the almost-firing line position to the firing-line position.

In one embodiment, the pipeline laying vessel comprises a single alignment device which is configured to cooperate with both the first and second pipe-moving device and which can move the pipe section to the firing line.

In a suitable embodiment, the first and second almost-firing line positions are the same positions. Thus, the pipe moving devices move the pipe sections to a common almost-firing line position, from which position the pipe section follow a same trajectory to the firing line. This is a simple setup of the trajectories which are followed by the pipe sections. In this embodiment, a single alignment device is provided

In one embodiment, the remote position is a position on the deck of the vessel. This is in practice a logical place to pick up the pipe sections. It is also possible that the remote position is a distance above the deck.

In a suitable embodiment, the remote position of the first pipe-moving device is different from the remote position of the second pipe-moving device. It is possible to have two pick-up locations, for instance when on deck short pipe sections are joined to form longer pipe sections in multiple work stations. The multiple work stations deliver pipe sections to the multiple remote positions from which remote positions the pipe sections are transported into the firing line and connected to the suspended pipeline.

In one embodiment, the remote position of the first pipe-moving device is the same as the remote position of the second pipe-moving device. This allows both pipe-moving devices to pick up or receive the pipe sections in one common location. This embodiment may be suitable for instance when no welding of short pipe sections into longer pipe sections takes place on board the vessel, but wherein the pipe sections are simply dispensed from a storage facility. Such a dispensing has no or only a minor risk of malfunctioning and can be performed at high speed. Thus there is no advantage in providing a double storage and dispensing facility, but it is more preferable to provide a single remote position.

In another embodiment, the first pipe-moving device and the second pipe-moving device are configured to operate without a J-lay tower, in that the at least first and second pipe-moving device are configured to support the pipe section in the firing line in cooperation with at least one alignment device during the joining of the pipe section to the pipeline and also support the respective first and second lowering devices, such that a separate J-lay tower for supporting a lowering device and/or an alignment device is not required.

In comparison with known J-lay systems, a simpler assembly is thus obtained.

In another embodiment, the first and second pipe-moving devices are pivotably mounted about a common axis. The first and second pipe moving devices can be positioned symmetrically about the firing line. The first and second pipe moving devices may be spaced apart and pivot about a common axis. Thus a simple, convenient arrangement is created in which all the parts have a logical position.

In another embodiment, the vessel comprises a frame which is pivotably connected to the hull of the vessel, wherein:

the first and second pipe-moving means are movably connected to said frame;

the first and second alignment devices are movably connected to said frame;

a hang-off table is connected to said frame.

This embodiment allows the J-lay system to be simply aligned with the natural angle of the pipeline. The hang-off table and other processing equipment are positioned in the desired angle with the frame. The first and second moving devices may have a stop to which they come to rest when they approach the firing line. The stops may move with the pivoting of the frame and thus ensures that the pipe-moving devices are automatically aligned with the firing line.

In one embodiment:

the first and second pipe-moving device are pivotably connected to said frame in order to move a pipe section from a remote position to a firing line position;

the first and second alignment devices are pivotably connected to said frame in order to move into and out of the firing line.

This pivotable movement is an effective solution to enable a reliable approach of the pipe sections to the firing line.

In another embodiment, the first and second movable lowering device are configured to travel along the first respectively the second pipe-moving device from an upper position to a lower position and vice versa, the first and second movable lowering devices being constructed to lower a pipeline or a pipe section. The first and second movable lowering devices are connected to the first respectively the second pipe-moving devices via one or more cables which extend to an upper end of the respective pipe-moving device, the movable lowering devices not being connected to the respective pipe-moving devices via a guiding arrangement which extends along the pipe-moving device. The lowering devices thus can be constructed as a simple hoisting block which is also used in a hoisting crane.

The return stroke can be made when the pipe-moving device extends substantially horizontally at the deck. For this end, extra supports on the deck of the vessel may be provided which, in the absence of guides or guiding means on the pipe-moving device, support the lowering device during its return stroke.

In another embodiment, the pipeline laying vessel comprises three, four or more pipe moving devices and/or three, four or more alignment devices. It is possible to further increase the speed by providing more moving devices. At a certain point, the positioning of the pipe sections may no longer form a primary constraint on the overall pipeline laying speed, but the joining of the pipe sections to the pipeline may form the primary constraint. At this point, it may no longer be useful to add extra pipe-moving devices. Also, more alignment devices can be provided.

In another embodiment, a first trajectory defined by the first remote position and the firing line position or the first almost-firing line position and a second trajectory defined by the second remote position and the second firing line position or second almost-firing line position extend at least partially parallel to one another, and converge at the firing line position or at the almost-firing line position.

This embodiment allows the trajectories to both extend substantially parallel to a longitudinal axis of the vessel.

In one embodiment, the first pipe-moving device is configured for lowering a pipe section into the first alignment device, and the second pipe-moving device is configured for lowering a pipe section into the second alignment device. To this end, at least one of the holding devices on the pipe-moving device comprises a pipe section lowering device for lowering the pipe sections into the alignment device. The pipe section lowering device may comprise a hoisting block or comprises a drive and rollers, or a tensioner or other kind of lowering device or combination.

The lowering device on the pipe-moving device may be an auxiliary lowering device or may be constructed as a main lowering device.

In an alternative embodiment, the at least first and second pipe-moving devices are cranes, the first and second cranes being configured for lifting pipe sections to the firing line position.

Cranes are widely available, simple and efficient. By providing two cranes, simple pipe-moving devices are provided, allowing simple and fast J-lay.

In another embodiment, the J-lay system defines two firing lines, the J-lay system comprising a suspension device for suspending the pipeline from the vessel, the suspension device being configured for moving the suspended pipeline between the first and the second firing line, the J-lay system configured for joining a pipe section to the pipeline in the first and in the second firing line. The suspension device may be a hang-off table, tensioners, friction clamps or any other suitable device and may shift from one firing line to the other. In this way, in one firing line the preparations for the joining of a pipe section to the pipeline are performed, while in the other firing line the actual welding and lowering takes place. This embodiment allows simple and fast J-lay.

In a suitable embodiment, the first and second pipe moving devices each comprise a pivotable beam at an upper end thereof, wherein the respective lowering devices are suspended from a free end of said pivotable beam, and wherein the pivotable beam is configured to pivot into the firing line when the pipe-moving device is positioned near the firing line, thereby allowing a combination of a pipe section and a lowering device connected thereto to move into the firing line.

In this way, the lowering device can be moved from an almost-firing line position to the firing line position.

A problem that may occur with the design of an eccentric loaded pipe moving device is that under high loads the tower may deform (bend). Since the hoisting block is not guided by the construction, the hoisting block may move away from the firing line. This may lead to problematic lowering of the pipeline. To compensate for the deformation of the pipe moving device it can be made very stiff, this requires additional steel and will increase the weight of the construction. Alternatively, the pipe moving device is designed taking into account the deformation when it is fully loaded. Yet another alternative is to make the hoisting block movably mounted to position the hoisting block into the firing line under all load cases.

The present invention also relates to a method of laying a pipeline from a pipeline laying vessel, the method comprising providing a pipeline laying vessel comprising a J-lay system which defines a firing line, the J-lay system comprising:

a first pipe-moving device configured for moving a pipe section from a first remote position remote from the firing line to a firing line position in the firing line,

a second pipe-moving device configured for moving a pipe section from a second remote position remote from the firing line to the firing line position in the firing line,

at least one lowering device for lowering a pipe section or pipeline in the firing line from an upper position to a lower position, the method comprising:

moving a pipe section to the firing line position by the first pipe-moving device; and

moving another pipe section to the firing line position by the second pipe-moving device.

The method offers the same advantages as those discussed in relation to the device, i.e. an increased speed and at least partial redundancy in the J-lay process.

In a suitable embodiment, the first and second pipe-moving devices have different remote positions, and pipe sections are moved to the firing line from the different remote positions. This allows a further redundancy in that the processes which take place prior to the picking up of pipe sections by the pipe-moving devices can also be provided in a double fashion.

In one embodiment, the first pipe-moving device and the second pipe-moving device alternately move a pipe section to the firing line position and/or the first and second lowering devices alternately lower a pipe section and the pipeline to which the pipe section is connected. The alternation increases the speed in a simple way.

In another embodiment, each first and second pipe-moving device comprises

a pivotable elongate structure and

holding devices which are movably mounted to said elongate structure in order to move relative to said elongate structure,

the method comprising:

pivoting a pipe section from a remote position to an almost-firing line position near the firing line by the elongate structure, and

moving the pipe section relative to the elongate structure from the almost-firing line position into the firing line with the movable holding devices.

The holding devices effectively allow accurate positioning, and enable a two step movement from the remote position to the firing lines position via an almost-firing line position in which pre-alignment can take place.

In another embodiment, the method comprises:

engaging the pipe section with an alignment device in the almost-firing line position and

moving the pipe section with the engaged alignment device into the firing line.

Thus, a part of the alignment process is removed from the critical path.

In another embodiment, the method comprises:

moving a first pipe section which has previously been connected to the first lowering device of the first pipe-moving device and to the first alignment device into the firing line;

aligning the first pipe section with the pipeline and joining the first pipe section with the pipeline;

lowering the first pipe section and the pipeline with the first lowering device;

uncoupling the lowering device from the pipeline;

moving the pipe moving device and the lowering device away from the firing line;

moving a second pipe section which has previously been connected to the second lowering device of the second pipe-moving device and to the second alignment device into the firing line;

aligning the second pipe section with the pipeline and joining the second pipe section with the pipeline;

lowering the second pipe section and the pipeline with the second lowering device;

uncoupling the second lowering device from the pipeline and moving the second pipe moving device and the second lowering device away from the firing line.

The present invention allows that a substantial part of the work on the second pipe section is performed during the time that the first pipe section is undergoing processing and joining with the pipeline.

In a further embodiment, the at least first and second pipe-moving devices are cranes, the method comprising lifting pipe sections to the firing line position or to the almost-firing line position with the cranes. Cranes are a traditional way of moving pipe sections to the firing line. Because cranes are versatile machines, using two or more cranes for this process is a simple way of increasing the speed and providing at least partial redundancy.

In a further embodiment, the at least first and second pipe-moving devices are pivotable beams, the method comprising pivoting pipe sections to the firing line position or to the almost-firing line position with the at least two pivotable beams. Pivotable beams are a simple way of moving the pipe sections to the firing line.

In the following, the aspects, features and advantages of the present invention will be elucidated further by reference to the annexed Figures illustrating exemplary embodiments. In the Figures, the same parts or parts having the same function have been identified with the same reference numeral.

### BRIEF DESCRIPTION OF THE FIGURES

FIG. 1 shows an orthogonal view of a J-lay system according to the invention;

FIG. 2 shows an orthogonal view of a J-lay system according to the invention in a next step;

FIG. 3 shows an orthogonal view of a J-lay system according to the invention in yet a next step;

FIG. 4 shows an orthogonal view of a J-lay system according to the invention in yet another next step;

FIG. 5 shows a schematic orthogonal view of a J-lay system of the invention with two pipe-moving devices;

FIG. 6 shows a rear view of the J-lay system according to the invention;

FIG. 7 shows a schematic side view of the J-lay system according to the invention;

FIG. 8 shows an alternative embodiment of a J-lay system according to the invention.

### DETAILED DESCRIPTION OF THE INVENTION

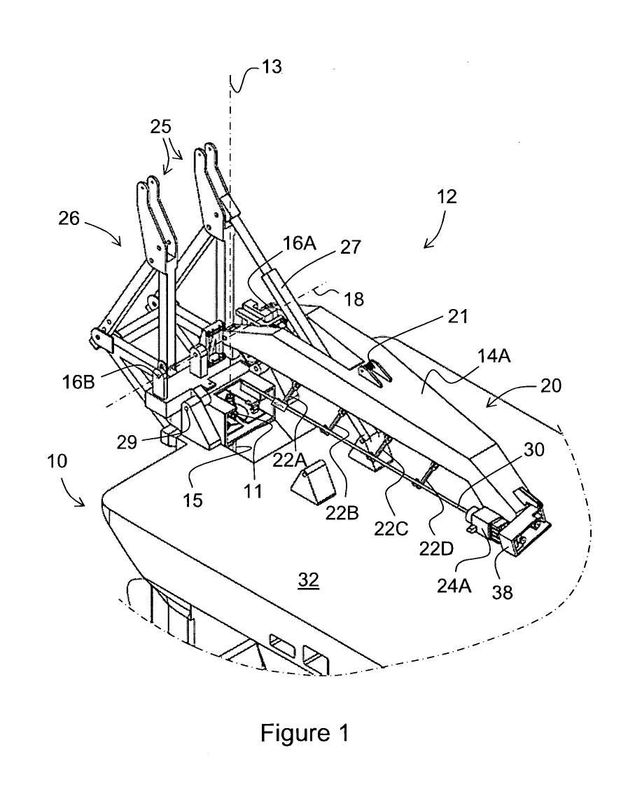

FIGS. 1-4 show a pipeline laying vessel 10 having a J-lay system 12. The J-lay system 12 comprises a hang-off table 11 which defines a firing line 13. The J-lay system comprises a first pipe-moving device 14A and a second pipe moving device 14B. In FIGS. 1-4, only the first pipe-moving device 14A is shown.

The first pipe moving device 14A is pivotable about hinges 16 which define a hinge axis 18. The first pipe moving device 14A is pivotable from a horizontal pick-up position 20 to a position 31 aligned with the natural angle of the pipeline 15. The position 31 may be vertical, but may also be another angle.

The pipe moving device 14A comprises holding devices 22A, B, C, and D. The holding devices 22A-D are connected via hinges (not shown) to the pipe-moving device 14A. The holder 22D is equipped with a drive 23 in order to allow lowering of the pipe section into the alignment device 34A. It is also possible that one of the other holding devices 22A-D is constructed to lower the pipe section into the alignment device. The drive 23 does not have the same lifting capacity as the lowering device 24A, but is generally only configured to lower a single pipe section into the alignment device. The drive may comprise any known drive in the field of the art.

The pipe moving device 14A has a different form than a conventional J-lay tower, in that it is asymmetric. The lowering device 24A is not positioned between two upright load carrying beams, but on one side of an elongate load carrying structure. This allows two pipe-moving devices 14A, 14B to be combined in a single J-lay system and to operate on a single firing line 13, as will be explained further below.

Further, the pipe-moving device 14A comprises a first lowering device 24A, which is sometimes referred to as a hoisting block. A frame 26 is provided for supporting the J-lay system in certain operating positions. The frame 26 is pivotable about a frame hinge 29 and the pivot angle can be varied by a beam 27 with a drive (not shown). A pipe section 30 is shown which is supported in a horizontal position in FIG. 1, i.e. a remote position. In this position, the moving device picks up the pipe section 30 from the deck 32 of the vessel or from an elevated position on the deck 32. The holding devices 22 comprise gripper members 33 to grip the pipe section 30. The position and orientation of the pipe section in all six degrees of freedom is controlled by the pipe moving device 14A.

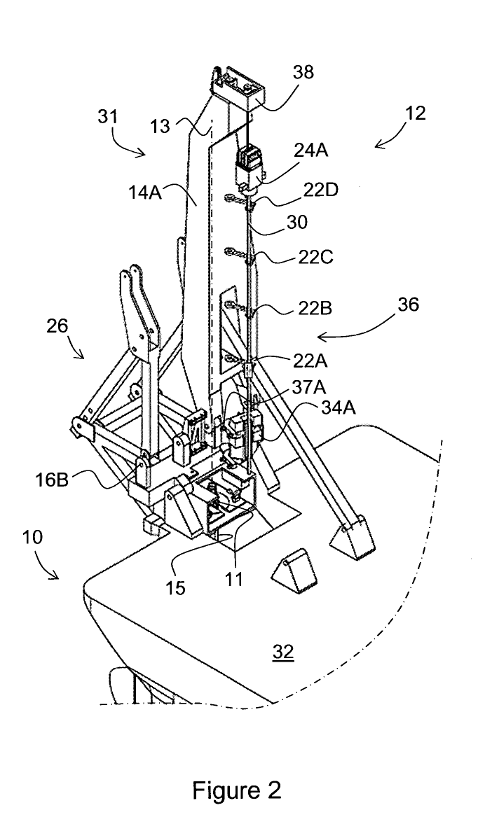

An upper part 25 of the frame is provided with a stop which engages with a stop 21 on the pipe-moving device 14A for stopping the pipe-moving device 14A in the firing line position 31 as is shown in FIG. 2.

FIG. 1 shows the system in a step wherein the pipe-moving means 14A pick up a pipe section 30 from the deck 32 of the vessel, or from an elevated position above the deck 32 of the vessel.

FIG. 2 shows a next step in the J-lay process, wherein the pipe moving device 14A is positioned such that the pipe section 30 extends substantially parallel with the firing line 13 which is determined by the natural angle of the pipeline. The pipe section 30 is at a position 36 close to, but not in the firing line 13.

A first alignment device 34A (sometimes referred to as an External Line-Up Tool or ELUT) is provided which is positioned close to the firing line 13. The alignment device is positioned close to the hang-off table 11. The alignment device 34A is connected to the frame 26 via hinges 37A. The alignment device is pivotable with the frame about the frame axis in order to be able to adapt the orientation to the natural angle of the pipeline, i.e. to extend parallel to the firing line 13.

The alignment device 34 is configured to engage the pipe section near the lower end of the pipe and grips the lower end of the pipe section, in particular a length of one-third or less of the total length of the pipe section.

As will be discussed later, a second alignment device 34B is also provided. In FIG. 2, the pipe section 30 is lowered into the alignment 34A device by the lowering device 24A.

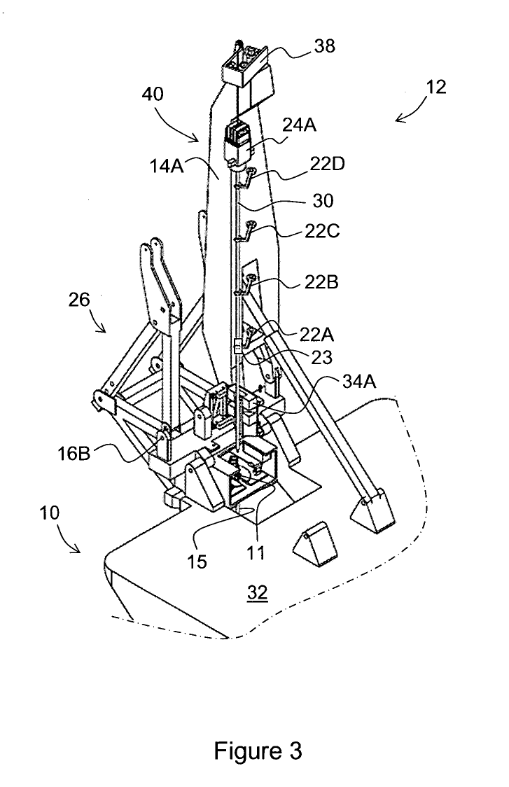

Subsequently, as shown in FIG. 3, the holding devices 22A-D and the alignment device 34A move the pipe section 30 from the position 36 into the firing line 13 and in alignment with the suspended pipeline 15. To this end, a pivotable beam 38 or shoulder member is provided at the upper end of the pipe-moving device 14A. The lowering device 24A is suspended from an end of said pivotable beam 38 via one or more cables (not shown). The lowering device 24A is not connected to the pipe-moving device 14A via guides or rails, as is customary in the prior art. By pivoting the beam 38 from a first position to a second position and pivoting the holding devices 22A-D, the lowering device 24A, the pipe section 30 and the holding devices 22A-D are moved into the firing line 13.

Further, the pivotable beams allows the first and second pipe-moving device 14A, 14B to pass one another without hitting or obstructing one another. To this end, the pivotable beam 38 is pivoted over a certain angle. In this way a clearance is created between the end of the pivotable beam 38 of the first pipe-moving device 14A and the end of the pivotable beam 38 of the second pipe-moving device 14B.

Although a pivot movement is shown, it is also possible that a translational movement is performed to position the pipe-section 30 from the position 36 into the firing line 13. No transfer operation is required for positioning the pipe section 30 in the firing line 13.

The pivotable beam 38 may be provided with a rail or guide 39 along which an upper block 39 of the lowering device 24A, 24B can be moved laterally. This may be necessary when a heavy load deforms the pipe-moving device 14A, 14B due to its eccentric position relative to the pipe-moving device 14A, 14B. Under influence of the heavy load, the pipe moving device may curve somewhat, causing the lowering device 24A, 24B to move laterally out of alignment with the firing line. 13. With the rail 39 and the movable upper block 41, the position of the lowering device 24A, 24B can maintained in the firing line 13.

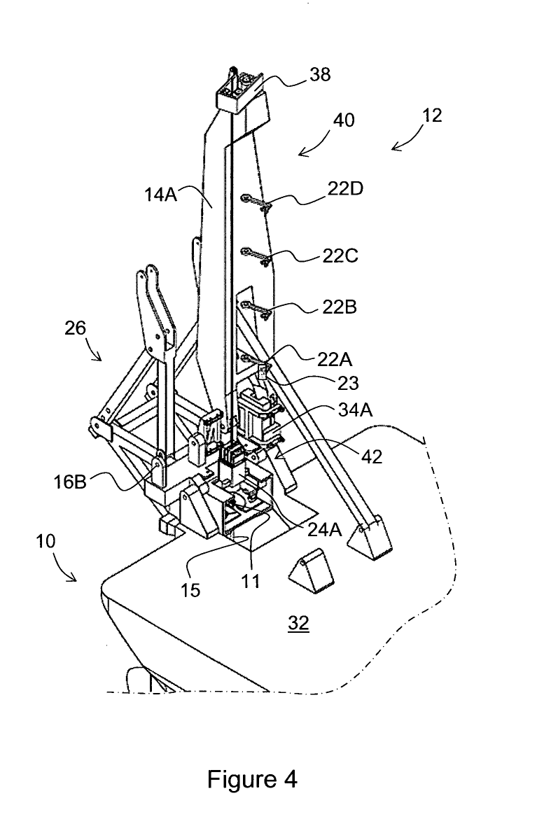

FIG. 4 shows the subsequent lowering of the pipe section 30 after it has been welded to the pipeline 15. First, the holding devices 22A-D pivot away from the firing line 13 in order to provide clearance for the lowering device 24A. Next, the lowering device 24A is lowered from an upper position 40 to a lower position 42, thereby making a stroke. Thus, the pipe section 30 and the pipeline 15 are lowered into the sea.

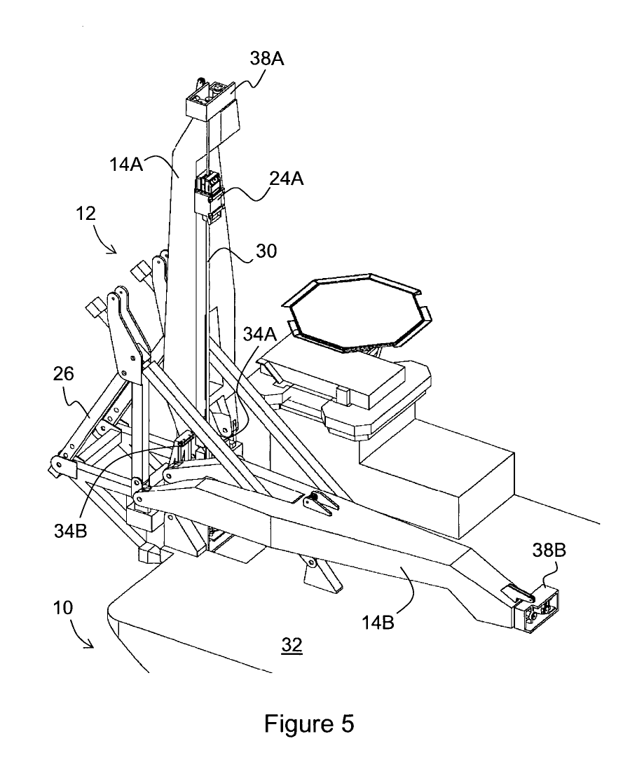

FIG. 5 shows the J-lay system 12 with both pipe moving devices 14A, 14B. The first lowering device 24A is shown. A second lowering device 24B is provided for the second pipe-moving device 14B, but not shown. A first alignment device 34A and a second alignment device 34B are provided. Two substantially complete pipe-positioning and alignment systems thus are provided. The welding station (not shown) and other processing equipment is shared by both pipe-positioning and alignment systems. Also, the hang-off table 11 is shared by both pipe-positioning systems. Other equipment is also shared.

In operation, the pipe-moving devices 14A, 14B alternately perform the steps shown in FIGS. 1-4. Both pipe-moving devices work in parallel, thereby significantly increasing the rate of J-lay. Since only a single firing line 13 is available, only one pipe-moving device 14 and one alignment device 34 can position a pipe section 30 in the firing line 30 at a given time.

However, it is also conceivable, that two firing lines 13 are provided and that the pipeline 15 is shifted back and forth from one firing line to the other and back with a movable hang-off table.

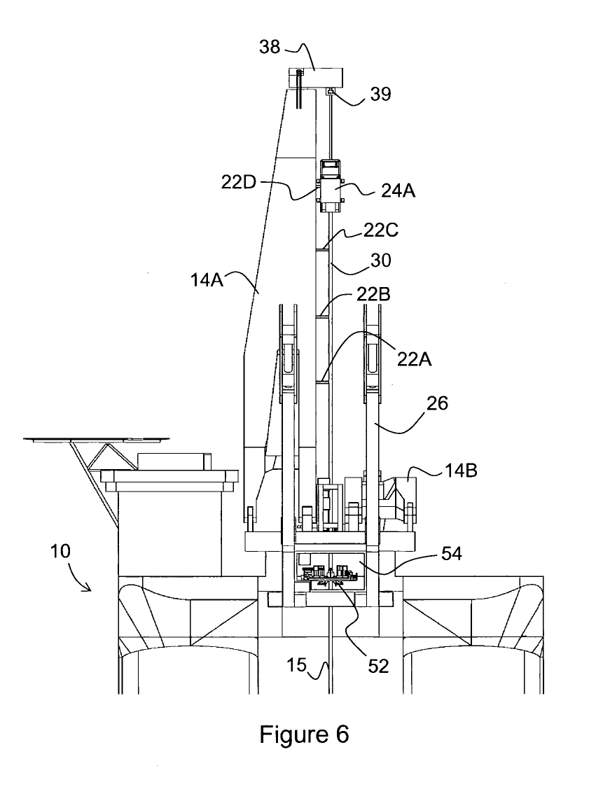

FIG. 6 shows a rear view of the vessel 10 which is a semi-submersible. Other types of vessels may also be used. One pipe moving device 14A is positioned substantially upright, and one pipe-moving device 14B is in a horizontal position for picking up a pipe section 30.

The horizontal position is also suitable for transit mode or survival mode for surviving a storm.

FIG. 6 further shows a hang-off table 52 and a welding station 54.

In an alternative embodiment with two firing lines, the pipeline laying vessel may comprise two joining stations for joining a pipe section to the suspended pipeline, a first joining station associated with the first firing line and a second joining station associated with the second firing line.

If two firing lines are provided, the method may comprise:

joining a first pipe section with the pipeline in the first firing line

lowering the first pipe section and the first pipeline;

moving the pipeline including the first pipe section to the second firing line;

joining a second pipe section with the pipeline in the second firing line;

lowering the second pipe section and pipeline.

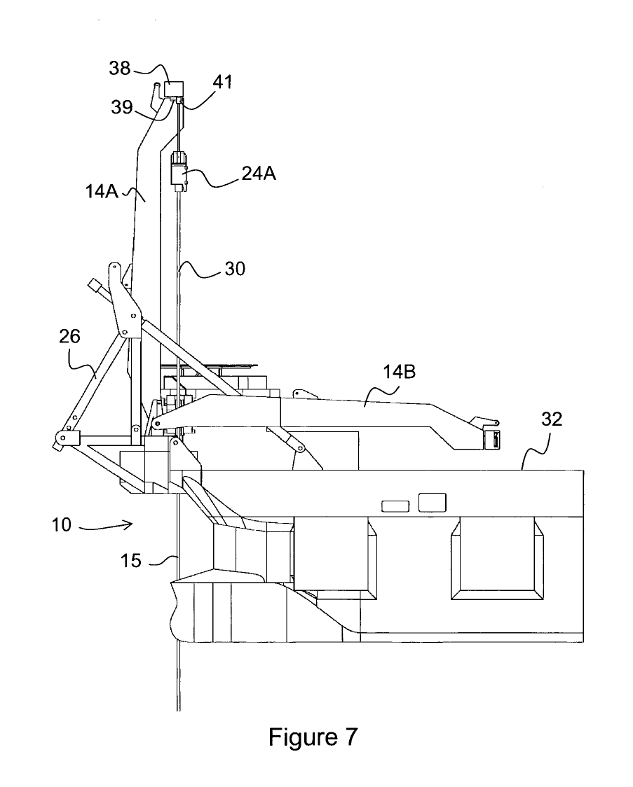

FIG. 7 shows the same system as FIG. 6, but now in a side view.

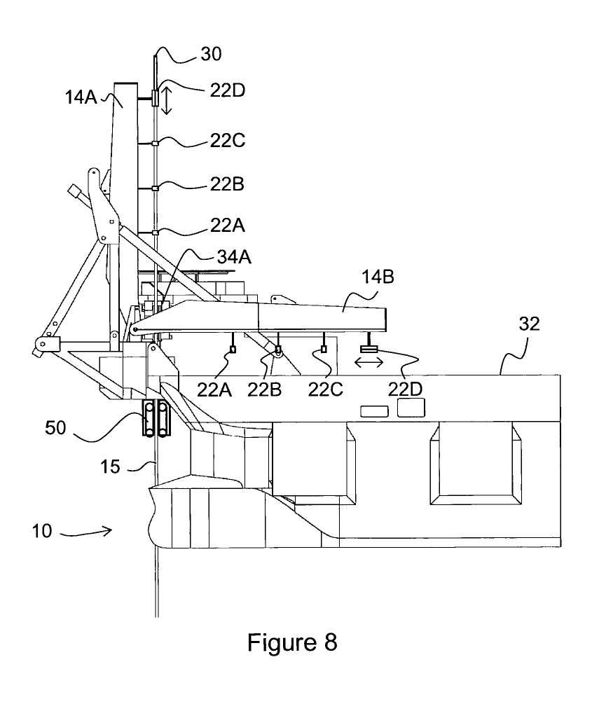

FIG. 8 shows an alternative embodiment of the J-lay system according to the invention. Instead of a lowering device that moves along the pipe moving device, the pipeline 15 is now held and lowered with a tensioner 50 below the welding station. It is possible to provide multiple tensioners 50 at this location. An advantage of this embodiment is that the pipe moving devices 14A, 14B can be constructed smaller and less heavy. The pipe moving devices 14A, 14B comprise holding devices 22A, B, C, and D. The holding devices 22A-D are connected via hinges (not shown) to the pipe-moving device 14A. The holder 22D is equipped with a drive 23 in order to allow lowering of the pipe section into the alignment device 34A. It is also possible that one of the other holding devices 22A-D is constructed to lower the pipe section into the alignment device. The drive 23 does not have the same holding capacity as the tensioner 50, but is generally only configured to secure a single pipe section 30 during upending and lowering it into the alignment device 34A. The drive may comprise any known drive in the field of the art.

It will be obvious to a person skilled in the art that the details and the arrangement of the parts may be varied over considerable range without departing from the spirit of the invention and the scope of the claims.

1-39. (canceled)

40. A pipeline laying vessel comprising a J-lay system which defines a firing line, the J-lay system comprising:
a first pipe-moving device configured for moving a pipe section from a first remote position remote from the firing line to a firing line position in the firing line; and
a second pipe-moving device configured for moving a pipe section from a second remote position remote from the firing line to the firing line position in the firing line; and
one lowering device for lowering a pipe section or pipeline in the firing line from an upper position to a lower position; or
a first lowering device for lowering a pipe section or pipeline in the firing line from an upper position to a lower position, and a second lowering device for lowering a pipe section or pipeline in the firing line from the upper position to the lower position.

41. The pipeline laying vessel of claim 40, wherein:
the first lowering device is movable into the firing line and out of the firing line to a first remote position remote from the firing line; and
the second lowering device is movable into the firing line and out of the firing line to a second remote position remote from the firing line.

42. The pipeline laying vessel of claim 40, wherein
the first pipe-moving device comprises a first elongate structure, wherein the first lowering device is movably constructed to make a stroke along the first elongate structure from an upper position to a lower position; and
the second pipe-moving device comprises a second elongate structure, wherein the second lowering device is movably constructed to make a stroke along the second elongate structure from an upper position to a lower position.

43. The pipeline laying vessel according to claim 40, wherein:
the first pipe-moving device is pivotably mounted on a hinge and is configured to pivot in order to move a pipe section from the first remote position to the firing line position; and
the second pipe-moving device is pivotably mounted on a hinge and is configured to pivot in order to move a pipe section from the second remote position to the firing line position.

44. The pipeline laying vessel according to claim 43, wherein a first trajectory defined by the first remote position and the firing line position and a second trajectory defined by the second remote position and the firing line position extend alongside one another.

45. The pipeline laying vessel according to claim 43, wherein the first and second remote position are located adjacent one another substantially on a same side of the firing line.

46. The pipeline laying vessel according to claim 44, wherein the first and second pipe moving devices are constructed to pass one another during the movement between the respective first and second remote positions and the firing line position.

47. The pipeline laying vessel according to claim 40, comprising at least two alignment devices, a first alignment device associated with the first pipe-moving device and a second alignment device associated with the second pipe-moving device, and wherein the first and second alignment devices are configured to engage pipe sections which are to be joined to the pipeline prior to the arrival of the pipe sections in the firing line position.

48. The pipeline laying vessel according to claim 40, wherein:
the first pipe-moving device is configured to move the pipe section to the firing line position via a first almost-firing line position in which first almost-firing line position the pipe section engages a first alignment device, wherein the first pipe-moving device and the first alignment device are constructed to jointly move the pipe section from the almost-firing line position to the firing-line position; and
the second pipe-moving device is configured to move the pipe section to the firing line position via a second almost-firing line position, in which second almost-firing line position the pipe section engages a second alignment device, wherein the second pipe-moving device and the second alignment device are constructed to jointly move the pipe section from the almost-firing line position to the firing-line position.

49. The pipeline laying vessel according to claim 40,
wherein the first and second pipe-moving device each comprise holding means for holding the pipe section; and
wherein the holding means are movably mounted to the respective pipe-moving devices, such that when the respective pipe-moving devices are positioned close to the firing line, the holding means can move the pipe section from an almost-firing line position to the firing line position.

50. The pipeline laying vessel according to claim 40, wherein the first and second remote positions are different positions.

51. The pipeline laying vessel according to claim 40, wherein the first and second remote positions are the same position.

52. The pipeline laying vessel according to claim 40, wherein the first pipe-moving device and the second pipe-moving device are configured to operate without a J-lay tower, in that the at least first and second pipe-moving device are configured to support the pipe section in the firing line in cooperation with at least one alignment device during the joining of the pipe section to the pipeline and also support the respective first and second lowering devices, such that a separate J-lay tower for supporting a lowering device and/or an alignment device is not required.

53. The pipeline laying vessel according to claim 40, comprising a frame which is pivotably connected to the hull of the vessel, wherein:
the first and second pipe-moving means are movably connected to said frame;
the first and second alignment devices are movably connected to said frame; and
a hang-off provision is connected to said frame.

54. The pipeline laying vessel according to claim 53, wherein:
the first and second pipe-moving device are pivotably connected to said frame in order to move a pipe section from a remote position to a firing line position; and
the first and second alignment devices are pivotably connected to said frame in order to move into and out of the firing line.

55. The pipeline laying vessel according to claim 40, wherein a first trajectory defined by the first remote position and the firing line position and a second trajectory defined by the second remote position and the second firing line position extend at least partially parallel to one another, and coincide at the firing line position.

56. The pipeline laying vessel according to claim 47,
wherein the first pipe-moving device is configured for lowering a pipe section into the first alignment device; and
wherein the second pipe-moving device is configured for lowering a pipe section into the second alignment device.

57. The pipeline laying vessel according claim 40, wherein the at least first and second pipe-moving devices are cranes, the first and second cranes being configured for lifting pipe sections on a cable to the firing line position.

58. The pipeline laying vessel according to claim 40, wherein the J-lay system defines two firing lines, the J-lay system comprising a suspension device for suspending the pipeline from the vessel, the suspension device being configured for moving the suspended pipeline between the first and the second firing line, the J-lay system configured for joining a pipe section to the pipeline in the first and in the second firing line.

59. A J-lay system operable to be mounted onto a vessel, the J-lay system comprising:
a first pipe-moving device configured for moving a pipe section from a first remote position remote from the firing line to a firing line position in the firing line; and
a second pipe-moving device configured for moving a pipe section from a second remote position remote from the firing line to the firing line position in the firing line; and
one lowering device for lowering a pipe section or pipeline in the firing line from an upper position to a lower position; or
a first lowering device for lowering a pipe section or pipeline in the firing line from an upper position to a lower position, and a second lowering device for lowering a pipe section or pipeline in the firing line from the upper position to the lower position.

60. A method of laying a pipeline from a pipeline laying vessel, the method comprising providing a pipeline laying vessel comprising a J-lay system which defines a firing line, the J-lay system comprising:
a first pipe-moving device configured for moving a pipe section from a first remote position remote from the firing line to a firing line position in the firing line; and
a second pipe-moving device configured for moving a pipe section from a second remote position remote from the firing line to the firing line position in the firing line; and
one lowering device for lowering a pipe section or pipeline in the firing line from an upper position to a lower position; or
a first lowering device for lowering a pipe section or pipeline in the firing line from an upper position to a lower position, and a second lowering device for lowering a pipe section or pipeline in the firing line from the upper position to the lower position;
the method comprising:
moving a pipe section to the firing line position by the first pipe-moving device; and
moving another pipe section to the firing line position by the second pipe-moving device.

61. The method according to claim 60, wherein the first pipe-moving device and the second pipe-moving device alternately move a pipe section to the firing line position and/or wherein the first and second lowering devices alternately lower a pipe section and the pipeline to which the pipe section is connected.

62. The method according to claim 60, wherein pipe sections are moved to the firing line from different remote positions.

63. The method according to claim 62, wherein pipe sections are moved to the firing line from different remote positions which are located adjacent one another substantially on a same side of the firing line.

64. The method according to claim 60, wherein the pipe sections are moved to the firing line from a single remote position.

65. The method according to claim 60, wherein each first and second pipe-moving device comprises:
an elongate structure; and
holding devices which are movably mounted to said elongate structure in order to move relative to said elongate structure;
the method comprising:
pivoting a pipe section from a remote position to an almost-firing line position near the firing line by the elongate structure; and
moving the pipe section relative to the elongate structure from the almost-firing line position into the firing line with the movable holding devices.

66. The method according to claim 60, comprising:
engaging the pipe section with an alignment device in the almost-firing line position; and
moving the pipe section with the engaged alignment device into the firing line.
